(19) United States
(12) Patent Application Publication
(10) Pub. No.: US 2005/0157209 A1
(43) Pub. Date: Jul. 21, 2005

(54) Image photographing apparatus and method

(75) Inventors: Min-Ho Cha, Seoul (KR); Yong-Seok Bang, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 10/997,983

(22) Filed: Nov. 29, 2004

(30) Foreign Application Priority Data
Jan. 16, 2004 (KR) 2004-3266

(51) Int. Cl. H04N 5/225; G03B 17/00; H04N 5/222

(52) U.S. Cl. 348/373; D16/202; 348/333.06

(57) ABSTRACT

An image photographing apparatus comprising a main body having a recording medium, a camera unit mounted to the main body to move between a first position and a second position and obtain an image, a display panel rotatably mounted at one side of the main body, and a battery connected to the other side of the main body. The camera unit is capable of photographing at both the first and the second positions, respectively.

### CROSS-REFERENCE TO RELATED APPLICATIONS

This application claims the benefit under 35 U.S.C. §119(a) of Korean Patent Application No. 2004-3266 filed Jan. 16, 2004, in the Korean Intellectual Property Office, the entire disclosure of which is incorporated herein by reference.

### BACKGROUND OF THE INVENTION

1. Field of the Invention

The present invention relates to an image photographing apparatus for photographing, recording and storing image information.

2. Description of the Related Art

Generally, camcorders for photographing a moving image and a still image have been considered representative examples of image information recording and reproducing apparatuses. The camcorder comprises a lens device, a signal converting device, a deck device for recording and reproducing a photographed image, and a display device. A cassette tape is usually used as the recording medium in the camcorder to record information of the photographed image. Recently, research on small-sized and light-weight image information recording and reproducing apparatuses using a hard disc drive has been in progress as life styles and living patterns have changed.

Conventional image photographing apparatuses are bulky and difficult to operate. Accordingly, consumers desire image photographing apparatuses that are compact, light-weight and easy to operate.

### SUMMARY OF THE INVENTION

An aspect of the present invention is to solve at least the above problems and/or disadvantages and to provide at least the advantages described below. Accordingly, an aspect of the present invention is to provide an image photographing apparatus which is compact and light-weight for portability and convenient use.

In order to achieve the above-described aspects of the present invention, there is provided an image photographing apparatus comprising a main body having a recording medium; a camera unit mounted to the main body to move between a first position and a second position and obtain an image; a display panel rotatably mounted at one side of the main body; and a battery connected to the other side of the main body. The camera unit is capable of photographing at both the first and the second positions, respectively.

The image photographing apparatus further comprises an auxiliary recording medium removably mounted to the main body.

The camera unit can pivot between the first and the second positions by a hinge unit mounted in the main body.

The main body comprises first and second recording buttons disposed on opposite sides relative to each other.

At least one of the recording buttons is exposed when the camera unit is in the first position, and is covered by the camera unit when the camera is in the second position.

The auxiliary recording medium is preferably mounted in a mounting part disposed between the display panel and the battery.

The auxiliary recording medium may be a portable universal serial bus (USB) recording medium.

### BRIEF DESCRIPTION OF THE DRAWING FIGURES

The above aspect and other features of the present invention will become more apparent by describing in detail exemplary embodiments thereof with reference to the attached drawing figures, wherein;

FIG. 1 is a perspective view showing an image photographing apparatus according to an embodiment of the present invention;

FIG. 2 is a side view schematically showing the structure of the image photographing apparatus of FIG. 1;

FIGS. 3 and 4 are perspective views showing different manners of use based on the positions of a camera unit according to an embodiment of the present invention; and

FIG. 5 is a perspective view showing the image photographing apparatus of FIG. 1 in which a USB storing medium is separated according to an embodiment of the present invention.

In the following description, the same drawing reference numerals are used for the same elements, features and structures throughout the drawings.

### DETAILED DESCRIPTION OF THE EXEMPLARY EMBODIMENTS

Hereinafter, embodiments of the present invention will be described in detail with reference to the accompanying drawing figures.

The matters defined in the description such as a detailed construction and elements are provided to assist in a comprehensive understanding of the invention. Thus, it is apparent that the present invention can be carried out with various changes and modifications to the exemplary embodiments described herein. Also, well-known functions or constructions, as described in the related art, will not be described in detail for the sake of clarity.

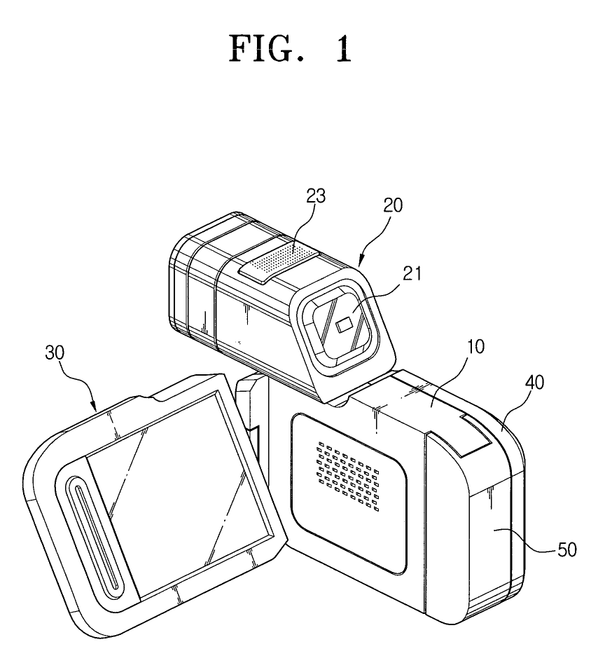

Referring to FIG. 1, an image photographing apparatus according to an embodiment of the present invention comprises a main body 10 having therein a recording medium, a camera unit 20 movably mounted in the main body 10, a display panel 30 rotatably mounted at one side of the main body 10, a battery 40 mounted at the other side of the main body 10, and an auxiliary recording medium 50.

A hard disc or a flash memory, which can store image data including moving images and a still image, may be provided as a recording medium mounted in the main body 10. In particular, the hard disc has been used in various fields since it is able to store a large volume of data in a compact size.

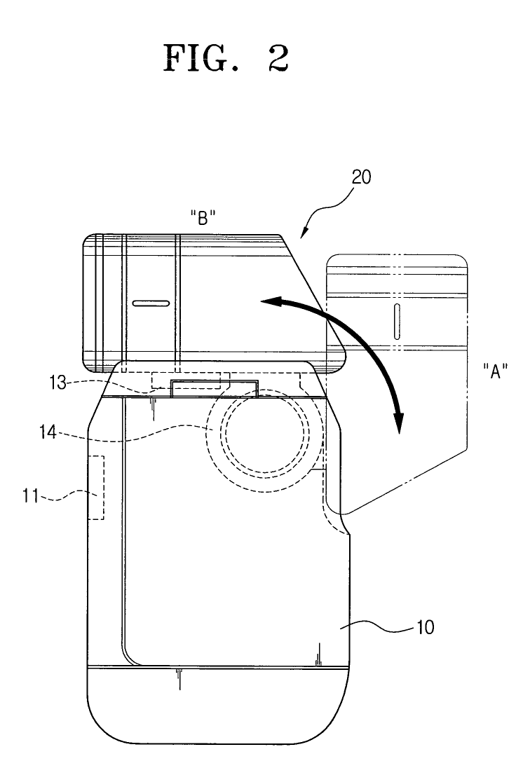

As shown in FIG. 2, a hinge unit 14 is mounted in the main body 10 to pivotably support the camera unit 20. The hinge unit 14 is received in the main body 10 and pivots by a predetermined angle, and preferably pivots by approximately 90°. The camera unit 20 is connected to the hinge unit 14 to move between a first position A and a second position B.

The camera unit 20 is connected to the hinge unit 14 and moves at the outside of the main body 10 and photographs at both the first and the second positions A and B. The camera unit 20 comprises a charge-coupled device (CCD) camera module and a zoom module within a lens barrel of an external camera. The camera unit 20 of this embodiment also comprises a zoom button 21 and a microphone part 23 as shown in FIG. 1.

The main body 10 includes a plurality of recording buttons such as a first recording button 11 and a second recording button 13. The buttons 11 and 13 are disposed on opposite sides to each other. If the camera unit 20 is in the second position B, the second recording button 13 is covered by the camera unit 20, thereby blocking the second recording button 13 from being used. Therefore, the first recording button 11 is used in this case. On the contrary, when the camera unit 20 is in the first position A, the second recording button 13 is exposed, and therefore, both of the first and second recording buttons 11 and 13 are available and may selectively be used.

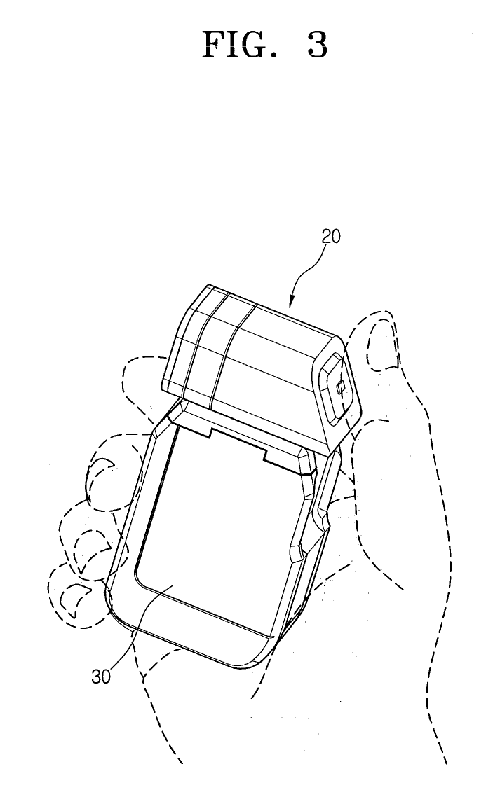

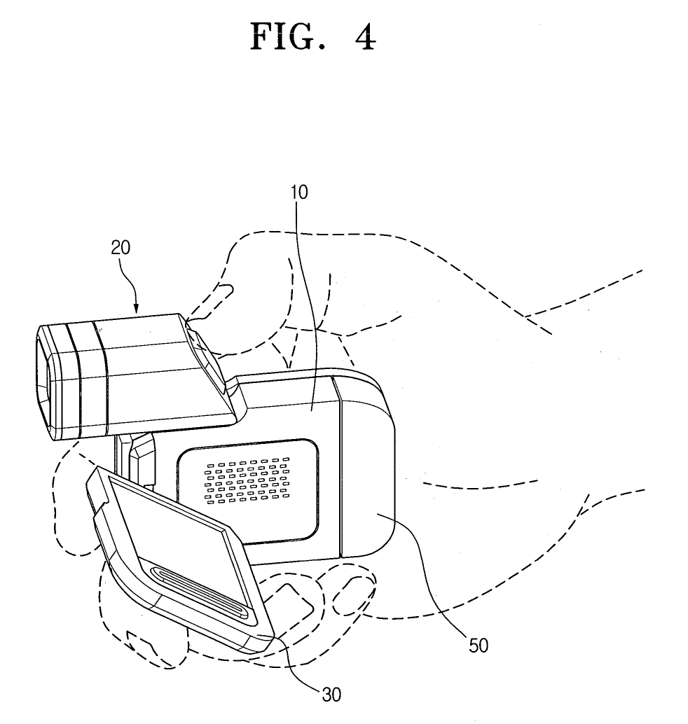

FIG. 3 shows the image photographing apparatus in use with the camera unit 20 in the second position B. In this position, the first recording button 11 would be used since the second recording button 13 is covered. FIG. 4 shows the camera unit 20 located in the first position A, and in this case, either button may be used, and the second recording button 13 may be more convenient to use.

The display panel 30 is mounted to open and close at the one side of the main body 10. A liquid crystal display (LCD) panel may be used for the display panel 30, and the display panel 30 can bi-axially rotate with respect to the main body 10. The display panel 30, being mounted to the main body 10, preferably is capable of having a greater area than the main body 10.

The battery 40 is mounted at the other side of the main body 10, that is, at the opposite side of the display 30. The battery 40 has substantially the same size and shape as the display panel 30. Accordingly, the battery 40 and the display panel 30 substantially form the outside appearance of the image photographing apparatus. The battery 40 is preferably removably mounted in the main body 10 using a general locking unit.

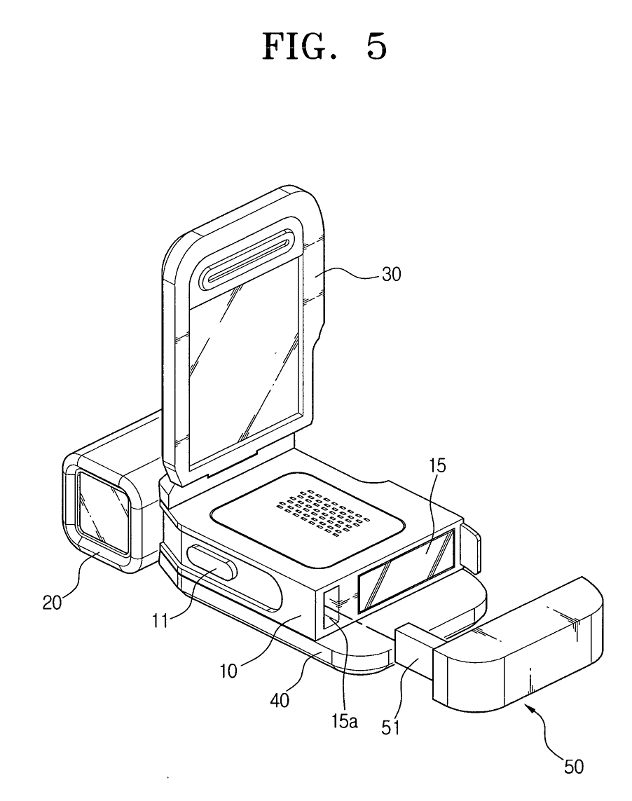

Referring to FIG. 5, a mounting part 15 for installing an auxiliary recording medium 50 is provided between the battery 40 and the display panel 30. The auxiliary recording medium 50 is connected to the mounting part 15 and may be a portable universal serial bus (USB) storage medium having a USB port 51. Therefore, the mounting part 15 is provided with a connecting port for connection with the USB port 51. By using of the portable USB storage medium as the auxiliary recording medium 50, the USB storage medium storing the photographed image data can be facilely used simply by connection to a personal computer.

As can be appreciated from the above description of the image photographing apparatus according to an embodiment of the present invention, the camera unit 20 can move to different positions with respect to the main body 10 and photograph from either position. Therefore, the user can use the image photographing apparatus in various configurations.

Also, since a plurality of recording buttons are provided, the recording buttons 11 and 13 can be conveniently used according to the position of the camera unit 20.

While an exemplary embodiment of the invention has been shown and described herein, it will be understood by those skilled in the art that various changes in form and details may be made therein without departing from the spirit and scope of the invention as defined by the appended claims.

1. An image photographing apparatus comprising:
a main body having a recording medium;
a camera unit mounted to the main body and adapted to move between a first position and a second position and obtain an image;
a display panel rotatably mounted at one side of the main body; and
a battery connected to the other side of the main body,
wherein the camera unit is capable of photographing at both the first and the second positions.

2. The image photographing apparatus of claim 1, further comprising an auxiliary recording medium removably mounted to the main body.

3. The image photographing apparatus of claim 1, wherein the camera unit can pivot between the first and the second positions by a hinge unit mounted in the main body.

4. The image photographing apparatus of claim 1, wherein the main body includes first and second recording buttons disposed on the opposite sides to each other.

5. The image photographing apparatus of claim 4, wherein at least one of the recording buttons is exposed when the camera unit is in the first position, and is covered by the camera unit when the camera is in the second position.

6. The image photographing apparatus of claim 2, wherein the auxiliary recording medium is mounted in a mounting part disposed between the display panel and the battery.

7. The image photographing apparatus of claim 6, wherein the auxiliary recording medium may be a portable universal serial bus (USB) recording medium.

8. A method for operating an image photographing apparatus comprising the steps of:
moving a camera unit mounted to a main body to a first position;
depressing a first recording button to input a first image;
moving said camera unit to a second position, wherein said first recording button is obstructed by said camera unit; and
depressing a second recording button to input a second image.

9. The method of claim 8, further comprising the step of:
selecting the recording medium on which to store said first or second images.

10. The method of claim 8, wherein said first image and said second image are substantially the same image.
